(19) United States
(12) Patent Application Publication
(10) Pub. No.: US 2005/0080741 A1
(43) Pub. Date: Apr. 14, 2005

(54) Method of providing indexed certificates of deposit

(76) Inventor: Michael Sherzan, Urbandale, IA (US)

Correspondence Address: DAVIS, BROWN, KOEHN, SHORS & ROBERTS, P.C.;THE FINANCIAL CENTER, 666 WALNUT STREET, SUITE 2500, DES MOINES, IA, 50309-3993, US

(21) Appl. No.: 10/926,153

(22) Filed: Aug. 25, 2004

Related U.S. Application Data
(63) Continuation of application No. 10/681,599, filed on Oct. 8, 2003.

(51) Int. Cl. G06F 17/60

(52) U.S. Cl. 705/42; 705/43

(57) ABSTRACT

A system and method providing for a service provider, acting as agent for one or more community banks to offer indexed certificates of deposit (ICDs) at an upfront, fixed cost, which have the benefits of an upside return opportunity, no downside risk, and FDIC insurance for qualified accounts. Customers' funds are deposited with the banking institution, then a portion of the funds are directed through an escrow agent to a hedge provider in exchange for an option to pay portion of the appreciation of the index, if any, on the ICDs. At maturity, the hedge provider pays the proportionate appreciation, if any, to the escrow agent, who in turn sends the appropriate portion of the appreciation to the participating bank institutions. The bank institutions then forward the appreciation, along with the initial purchase price of the ICDs, on to the customer.

### BACKGROUND OF THE INVENTION

1. Field of the Art

The present invention relates to a system and method that allows community banks to offer indexed certificates of deposit (ICDs), and more specifically, a system and method to allow several community banks to offer their customers indexed certificates of deposit (ICDs) which have the benefits of an upside return opportunity, no downside risk, and FDIC insurance for qualified accounts, all at a fixed, upfront cost to the bank.

2. Background of the Art

Index-linked deposits and investment products have been around since the mid-1980's. There has been significant growth in index-linked financial products in recent years through the introduction of equity index annuities offered by insurance companies, index-linked mutual funds offered by investment companies, and ICDs offered by large regional banks. Community banks, however, have been precluded from entering the index-linked deposit market because of the large cost of self-insuring or hedging the risk associated with index-linked deposits combined with a relatively small investment base. This is a significant loss of revenue for community banks, considering that equity-indexed annuity sales in 2002 grossed over $11.7 billion dollars. Community banks are continually losing both deposits and customers to other investment entities and products.

The present invention involves offerings of Indexed Certificates of Deposit (ICDs) which are certificates of deposit issued by a community bank where interest is determined based on a percentage of the performance of a market index, such as a stock index, over a period of time. The investor recieves the benefit of upside return opportunity, no downside risk through a principal protection feature, and since this is a bank deposit, Federal Deposit Insurance Corporation (FDIC) Insurance for qualified retirement plans, college savings accounts, individual, and commercial accounts.

The present invention alleviates the problem that has existed whereby community banks have been unable to compete with insurance companies and large regional banks in the indexed-linked financial product market. The present invention provides a system and method by which smaller community banks can tap into the growing market for index-linked deposits and can lock-in a fixed cost for each ICD issue prior to the issuance of the ICDs. By knowing the cost of the ICDs upfront, the bank does not have the risk of being obligated to pay out a large amount of money upon maturity of the ICDs in the event the stock market increases dramatically. This system obtains and assigns the bank a hedge, provided by an outside hedge provider, to protect against substantial increases in the linked index. The hedge provider effectively assumes the risk of paying the bank the designated performance of the stock index to each ICD customer at a fixed price to the bank.

This system also allows community banks the opportunity to lure back customers and deposits they have lost to the larger regional banks, insurance companies, and investment companies due to the inability of the community banks heretofore to offer index linked funds. The ICDs provide participating banks with a source of deposits for a fixed number of years that they would not otherwise have from fixed-rate CDs or other investment offerings. This method also provides investors with a middle-ground investment that has the capacity to grow with the market, but does not have the risk that is normally involved in market linked investments.

### SUMMARY OF THE INVENTION

The problems of the prior art are solved by the system or method of the present invention, which comprises four key players: an escrow agent, a number of banking institutions, one or more hedge providers, and a service provider. The service provider begins by securing an option agreement from one or more hedge providers. This option agreement establishes that, for a fixed price (the option premium) on the issue date, the hedge provider agrees to pay a certain percentage of any increase in the selected market index to the banks upon maturity of the to-be-issued ICDs. This percentage, called the participation rate, is quoted to the customers at sale of the ICD. In the preferred embodiment of the invention, the ending price of the index is determined by averaging the value of the index at fixed points during the issue period.

For each ICD issuance, the bank institutions sell a fixed number of ICDs to their customers during a set period of time called the offering period. At the end of the offering period, on the issue date of the ICDs, the bank institutions forward a portion of the money received from sale of the ICDs to the escrow agent. The escrow agent, in turn, aggregates the bank payments, and sends the servicing fee to the service provider and the option premium to the hedge provider.

Upon maturity, the hedge provider forwards the participation rate of return of any increase in the selected market index to the escrow agent. The escrow agent forwards these funds on to each of the participating bank institutions according to its level of subscriptions. The bank institution then pays the customer the initial purchase price of the ICD, along with the corresponding share of any interest it has received from the escrow agent.

These and other objects of the present invention will become apparent to one skilled in the art upon reference to the following specification, drawings, and claims.

### BRIEF DESCRIPTION OF THE INVENTION

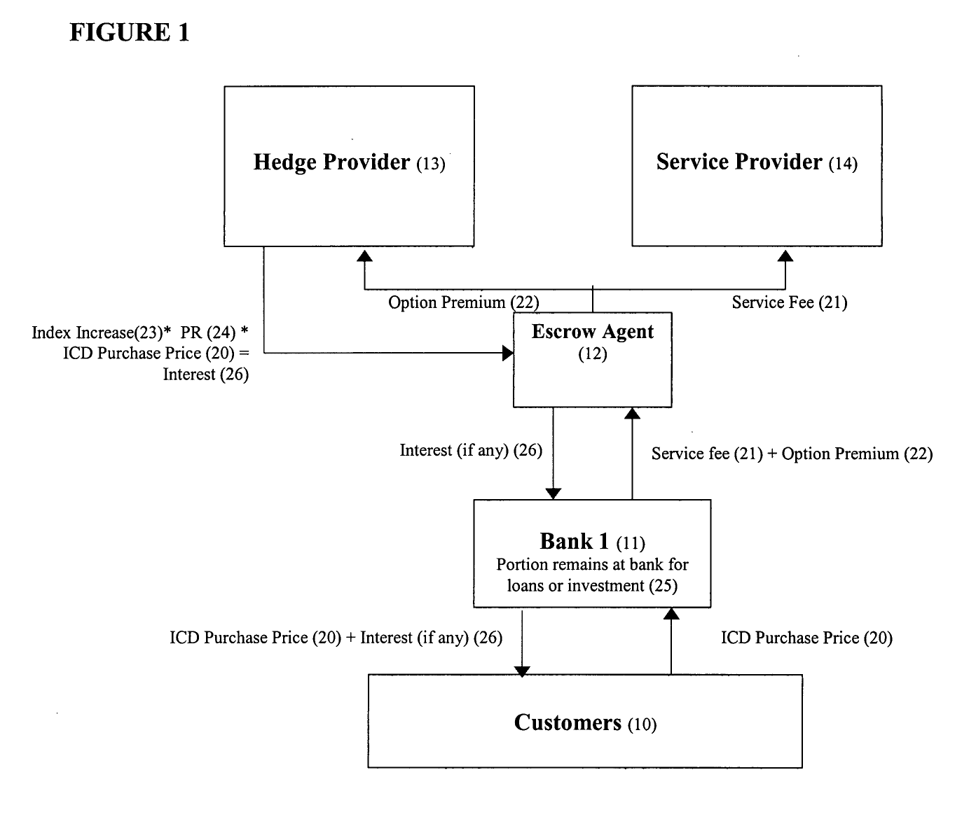

FIG. 1 is an overall schematic view of the flow of money between the key players during an ICD issue period.

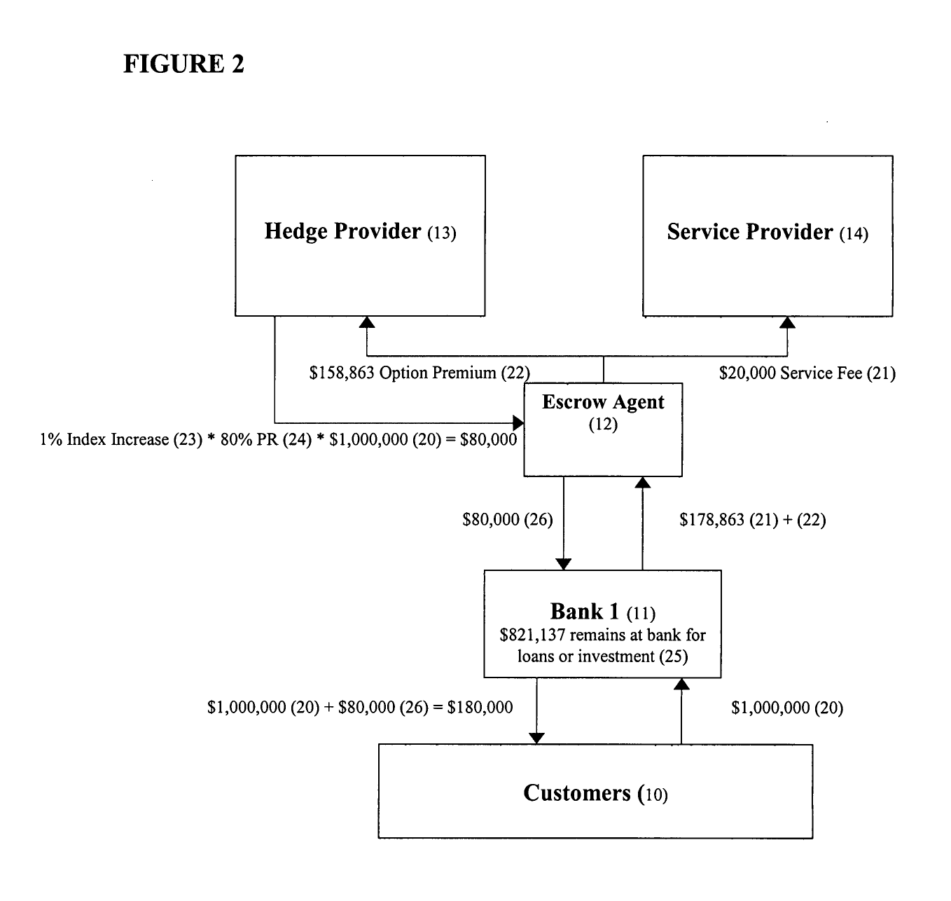

FIG. 2 is an overall schematic view of the flow of money between the key players during the ICD issue period of Example 1.

### DETAILED DESCRIPTION OF THE INVENTION

Index-linked deposits and investment products provide investors with an investment vehicle which has a return rate that is determined by the change in a market index over the period of time between a starting date, typically the issuance date of the products, and the maturity date of the product. For example, a Dow Jones Index-linked certificate of deposit pays return that is determined by the change in the Dow Jones Average between the issue date and the maturity date. Of course, most of the products return less than the actual increase in the index so as to provide a fund out of which the seller of the products receives a fee for the service of providing the products to the public.

Another type of product is also known wherein the seller will agree to return the entire principal to the investor even if there is a decline in the index over the period from issuance to maturity. The seller financial institution then charges a relatively higher fee to cover not only the cost of offering the product but also to cover the risk associated with a larger than anticipated increase in the index. This fee is usually recovered by a reduction in the portion or percentage of the increase in the index that is paid to the investors after the maturity date.

Virtually any market index can be used as a basis for determining the appreciation or interest (more accurately, the return rate since not all products guarantee a positive return rate) that is paid on the principal invested by the investor. There is also available to the investor in appropriate circumstances the protection offered by Federal Deposit Insurance Corporation. It will be appreciated that products which proved a guaranteed return of the principal and the possibility of a high participation rate in any increase in the market index will be popular at times where there have been recent decreases in the equity markets.

As used in this specification, the term “interest” is used to include the amount of money paid on an ICD at maturity that is in addition to the amount of principal. The term “market index” includes any index that is reliably by financial markets over at least the period between issuance and maturity of the ICDs under consideration. A “community bank” includes banks, savings banks, credit unions, and the like that have generally less than about two billion dollars in deposits.

The ICDs are issued on a predetermined day called the issue date. Referring to FIG. 1, the service provider 14 recruits a number of bank institutions 11 to participate in an issuance of ICDs. Prior to the issue date, the service provider 14 contacts one or more hedge providers 13 to negotiate the cost of a non-speculative call option to pay market interest upon based on the designated performance of a particular stock interest. This option premium 22 is dependent on, inter alia, the participation rate 24, which is the percentage of the stock option increase received by the customer. The higher the participation rate, the higher the option premium 22.

An ISDA Master Agreement, or other suitable agreement, is established between the service provider and the hedge providers to govern the option transaction. The option agreement lays out the means by which, for a fixed option premium on the issue date paid by the bank institutions 11, the hedge provider 13 agrees to pay a certain percentage of the increase, if any, in a particular market option on the maturity date of the ICDs. The service provider 14 also establishes an arrangement with an escrow agent 12, which acts as an independent third party to facilitate transactions between the bank institutions 11 and the hedge provider 13.

During the offering period, the participating bank institutions sell ICDs to customers 10 in incremental amounts. On the issue date, the bank institutions 11 forward a portion of the money from the sale to the escrow agent 12. A portion of that forwarded money goes to the service provider 14 as a service fee 21. The escrow agent 12 aggregates the other portion of the money from all the participating banks 11 and forwards this to the hedge provider 13 as the premium cost of the option 22.

In the preferred embodiment, the portion of money 25 that remains at the bank institution 11 is the present value of the total ICD purchase price at maturity, evaluated at the US currency swap rate. This ensures that even if the bank institution 11 does not otherwise invest the money it retains, it will retain the initial value of the ICDs over the period of time until maturity. Thus, the participation rate 24 can be modified in relation to the option premium 22 and service fee 21 to retain the preferred amount of money at the bank institutions 11.

In the case of the market index being the stock index, the interest rate 26 of the ICD returned to the customer 10 is the stock index percentage increase 23 multiplied by the participation rate 24 multiplied by the initial value of the ICD 20. The stock index percentage increase is calculated by taking the final stock index minus the initial stock index. That number is then divided by the initial stock index. The preferred embodiment of the invention calculates the final stock index as an average of the stock index at twelve three-month periods prior to the maturity date of the ICDs.

Upon maturity of the ICDs, the hedge provider pays to the escrow agent 12 the index increase 23, if any, at the appropriate percentage rate 24, accrued by an increase in the stock index. The escrow agent 12 then distributes this interest, if any, to the bank institutions 11. The bank institution then distributes the ICD Purchase Price 20 plus any interest to the customers 10.

If the increase in the stock index is negative, or zero, the hedge provider 13 does not pay any money to the escrow agent 12, and the bank institution 11 simply returns the initial value of the ICD 20 to the customer 10.

### EXAMPLE I

Referring to FIG. 2, this example is based on a 5-year $1,000,000 ICD offer, the minimum investment by any customer being $1,000 and the ICDs being sold in increments of $1,000. The service provider 14 gets a quote from the hedge provider 13 for these ICDs based on the stock index value of a particular stock index at a 100% participation rate, as shown in Table 1.

TABLE 1

| | | |
|---|---|---|
| Amount of Deposits (ICDs) Sold | $1,000,000 | 100% |
| Option Premium Quoted by Hedge Provider | $198,000 | 19.86% |
| for 100% Participation | | |
| Present value of $1,000,000 at maturity | $821,137 | 82.11% |
| Free Cash available for Premium and | $178,863 | 17.86% |
| Servicing fee | | |
| Participation rate that can be offered | | 80% |
| to customers | | |
| Bank Institution Cost= | | |
| Option Premium at 80% Participation | $158,863 | 15.89% |
| Service Fee | $20,000 | 2.00% |
| Amount remaining in bank for | $821,137 | 82.11% |
| loan/investment | | |

This quote is $198,600 on a $1,000,000 ICD offering. The service provider 14 charges the bank institutions 11 a 0.02% service fee, or $20,000. Based on a 30-day moving average of the United States Currency 5-year swap rate, the service provider 14 determines that the present value of $1,000,000 in 5 years the maturity date of the ICDs is $821,137. Therefore, the bank institutions can offer their customers ICDs with an 80% participation rate in order to preserve enough of the deposit in the bank, and afford to pay the option premium of $158,863 as well as the service fee of $20,000.

The bank institution 11, during the offering period, sells $1,000,000 worth of ICDs or 1,000 ICDs worth $1,000 each to its customers 10. On the issue date of the ICDs, the bank institution 11 wires $178,863 to the escrow agent 12. The escrow agent 12, in turn, wires the $158,863 option premium 22 to the hedge provider 13, and $20,000 servicing fee 21 to the service provider 14.

During the 36 months prior to the maturity date, the closing stock index is taken at 3-month intervals and averaged to find the final index value. The index increase 23 is calculated by taking the final index minus the initial index and dividing that number by the initial index. The index increase is then multiplied by the 80% participation rate and the initial purchase price of the ICDs, $1,000,000, to get the total amount of interest paid on the ICDs. Assuming this index increase is equal to 0.01 or 1%, the total amount of interest 26 paid by the hedge provider 13 is $80,000. The escrow agent 12 collects the $80,000 from the service provider, and distributes the appropriate amount of interest to each bank institution 11. The bank institution 11 then returns the $80,000 of interest 26, along with the original ICD purchase price of $1,000,000 26 to the customer 10 for a total of $1,080,000.

Although the invention has been described with respect to a preferred embodiment thereof, it is to be also understood that it is not to be so limited since changes and modifications can be made therein which are within the full intended scope of this invention as defined by the appended claims.

1. A method for providing bank institutions with the ability to issue indexed certificates of deposit to customers at a fixed cost to the bank, comprising the steps of:
(a) obtaining a premium cost on an option based on a predetermined maturity date from one or more hedge providers;
(b) aggregating option premiums from the bank institutions and directing them to the hedge provider;
(c) paying of option premiums to the hedge provider to purchase an option;
(d) assigning an interest in the option to each of the bank institutions;
(e) providing for sale of indexed certificates of deposit by bank institutions, in which the interest rate on such certificates is determined by a change in the index at maturity; and
(f) providing for a hedge on the bank institutions' duty to pay the customer interest on the indexed certificates of deposit through the value of the option interest held by the bank.

2. The method of claim 1, where the price of the option is dependent on the percent of the increase in the index that is paid to the buyer of the ICDs at maturity.

3. The method of claim 1, where the indexed certificates of deposit are purchased by the buyer at incremental amounts.

4. The method of claim 1, where the interest paid by the bank is funded by the value of the option interest held by the bank and sold by the hedge provider.

5. The method of claim 1, where transactions are settled between bank institution, the hedge provider and service provider through an escrow agent.

6. The method of claim 1, where the index comprises an equity market index.

7. The method of claim 6, where the index comprises a stock fund index.

8. The method of claim 7, where the index comprises the Dow Jones Industrial Average Index Fund.
